(19) United States
(12) Patent Application Publication
(10) Pub. No.: US 2003/0078878 A1
(43) Pub. Date: Apr. 24, 2003

(54) Systems and methods for evaluating commercial real estate property using stochastic vacancy information

(76) Inventor: Lorinda R. Opsahl-Ong, Darien, CT (US)

Correspondence Address: BUCKLEY, MASCHOFF, TALWALKAR, & ALLISON, 5 ELM STREET, NEW CANAAN, CT, 06840, US

(21) Appl. No.: 10/045,468

(22) Filed: Oct. 22, 2001

(51) Int. Cl. G06F 17/60

(52) U.S. Cl. 705/38

(57) ABSTRACT

Systems and methods are provided for evaluating a property using stochastic vacancy information. According to one embodiment, a first stochastic value associated with a property is determined. For example, an interest rate or a market rent associated with the property may be determined. A second stochastic value, associated with vacancy information, is also determined. The first and second stochastic values are then used to predict income and/or debt service coverage ratio information associated with the property. The determinations of the stochastic values can be repeated in accordance with a Monte Carlo simulation to evaluate a potential loan associated with the property.

### FIELD

The present invention relates to commercial real estate property. In particular, the present invention relates to systems and methods for evaluating a financial performance of commercial real estate property using stochastic vacancy information.

### BACKGROUND

The future financial performance of a commercial real estate property, such as a multi-unit office building, often needs to be evaluated. For example, a lender may need to predict income that will be generated by a property when evaluating a potential loan associated with the property (e.g., to determine the likelihood and severity of a loan default).

Currently, such an evaluation may be performed based on a set of “most-likely” values that are associated with the property (e.g., values that are associated with the property directly, with a lease, or with a potential loan) and lenders typically value property using a five year discounted cash flow approach. For example, a lender may estimate that the average interest rate during the next five years will most likely be 6.50%, the average market rent will most likely be $25.25 per square foot, and the property will most likely remain vacant for six months when a tenant's lease expires. Obviously, such an approach relies on subjective values (e.g., someone must determine what the “most-likely” average interest rate will be). Moreover, the approach does not take into account the effect that various combinations of values can have (e.g., a slightly above average interest rate combined with a slightly above average vacancy period). A similar problem arises with a “worst-case” analysis. That is, an analysis based on an expected worst case interest rate, market rent, and vacancy period will not take into account combinations of values that differ from the worst case.

Another approach is to evaluate a property and/or a potential loan using “what-if” scenarios. For example, a lender may perform a first evaluation assuming that: (i) the average interest rate will be 6.25%, (ii) the average market rent will be $25.00 per square foot, and (iii) the average vacancy period will be three weeks. A second evaluation may then be performed assuming that: (i) the average interest rate will be 6.50%, (ii) the average market rent will be $25.20 per square foot, and (iii) the average vacancy period will be two weeks. A similar approach is to evaluate the property and/or the potential loan using “range estimates” (e.g., assuming that the average interest rate will be from 6.25% to 6.75%). In either case, the evaluations can be time consuming (e.g., a lender may not feel comfortable until a large number of “what-if” scenarios have been created) and typically result in a need for subjective interpretation in order to predict the default rate or loss amount in the case of a loan, or the distribution of return in the case of an equity (e.g., a lender may fail to anticipate a particular combination of values).

As a result of these disadvantages, many lenders lack meaningful pricing information when making capital investment decisions associated with property.

### SUMMARY

To alleviate problems inherent in the prior art, the present invention introduces systems and methods for evaluating a property using stochastic vacancy information.

According to one embodiment, a first stochastic value associated with a property is determined. A second stochastic value, associated with vacancy information, is also determined. According to some embodiments, a random renewal is also determined. The first and second stochastic values are then used to predict income associated with the property.

According to another embodiment, a series of stochastic interest rate, market rent, and vacancy values associated with a property over a period of time are determined. Debt service coverage ratio information is then predicted based on the stochastic values in accordance with a Monte Carlo simulation, and a potential loan is evaluated based on the debt service coverage ratio information.

According to yet another embodiment, a stochastic vacancy value associated with a property is determined. The stochastic vacancy value is then used to predict income associated with the property.

One embodiment comprises: means for determining a first stochastic value associated with the property; means for determining a second stochastic value associated with the property, the second stochastic value being associated with vacancy information; and means for predicting income associated with the property based on the first and second stochastic values.

Another embodiment comprises: means for determining a series of stochastic interest rate values associated with the property over a period of time; means for determining a series of stochastic market rent values associated with the property over the period of time; means for determining a series of stochastic vacancy values associated with the property over the period of time; means for predicting debt service coverage ratio information associated with the property based on the stochastic values, wherein said determinations of the stochastic values are repeated, and the predicting is performed in accordance with a Monte Carlo simulation; and means for evaluating a potential loan based on the debt service coverage ratio information.

Yet another embodiment comprises: means for determining a stochastic vacancy value associated with a property; and means for predicting income associated with the property based on the stochastic vacancy value.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is an information flow diagram according to some embodiments of the present invention.

FIG. 2 is a flow chart of a method according to some embodiments of the present invention.

FIG. 3 is a functional diagram overview of an evaluation system according to some embodiments of the present invention.

FIG. 4 is a block diagram of an evaluation device according to an embodiment of the present invention.

FIG. 5 illustrates an evaluation display according to one embodiment of the present invention.

FIG. 6 is a tabular representation of a portion of an interest rate information database according to an embodiment of the present invention.

FIG. 7 is a tabular representation of a portion of a market rent information database according to an embodiment of the present invention.

FIG. 8 is a tabular representation of a portion of a vacancy information database according to an embodiment of the present invention.

FIG. 9 is a tabular representation of a portion of an evaluation database according to an embodiment of the present invention.

FIG. 10 is a flow chart of a Monte Carlo loan evaluation method according to some embodiments of the present invention.

FIG. 11 is a flow chart of a loan workout method according to some embodiments of the present invention.

FIG. 12 is a flow chart of a multi-unit evaluation method according to some embodiments of the present invention.

FIG. 13 is a flow chart of a single unit evaluation method according to some embodiments of the present invention.

### DETAILED DESCRIPTION

Embodiments of the present invention are directed to systems and methods for evaluating a “property.” As used herein, the term “property” may refer to anything (e.g., real estate property) that can be associated with vacancy information. For example, a property may be an office building or a shopping mall with a number of units that can be occupied by tenants. The term property may also refer to a group of properties (e.g., a number of different apartment buildings).

Moreover, embodiments are directed to systems and methods for evaluating a property using “stochastic” information. As used herein, the term “stochastic” information may refer to any random, semi-random, or pseudorandom information or information predicted based on chance and/or probability.

Information Flow Diagram

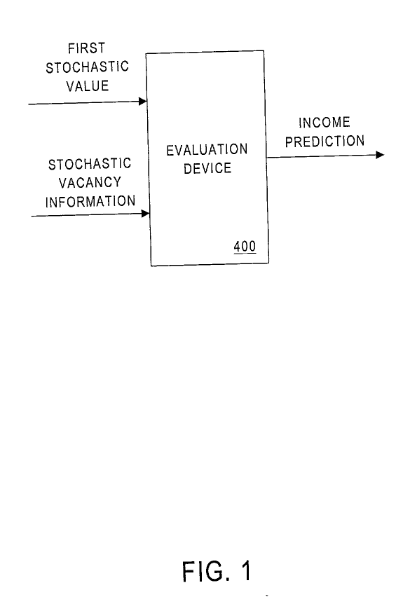

Turning now in detail to the drawings, FIG. 1 is an information flow diagram according to some embodiments of the present invention. As can be seen, an evaluation device 400 receives stochastic information, including a first stochastic value and stochastic vacancy information. The evaluation device 400 then generates an income prediction based on this stochastic information.

The evaluation device 400 may be any device capable of performing the various functions described herein. The evaluation device 400 may be, for example, a personal computer (PC), a server, a portable computing device such as a laptop computer or Personal Digital Assistant (PDA), or any other appropriate storage and/or communication device. According to one embodiment, the evaluation device 400 is a PC capable of running Monte Carlo simulations using the CRYSTAL BALL™ software program from DECISIONEERING, INC.

Although a single evaluation device 400 is shown in FIG. 1, any number of evaluation devices 400 may be included in accordance with the present invention. According to one embodiment, the evaluation device 400 also exchanges information via a communication network (not shown in FIG. 1). The communication network may comprise, for example, a Local Area Network (LAN), a Metropolitan Area Network (MAN), a Wide Area Network (WAN), a proprietary network, a Public Switched Telephone Network (PSTN), a wireless network, and/or an Internet Protocol (IP) network such as the Internet, an intranet, or an extranet. For example, the evaluation device 400 may receive market rent forecasts or other market information from a third-party service and/or transmit an income prediction to a remote user. According to one embodiment, the evaluation device 400 may be associated with a Web-based tool (e.g., a user may provide and/or receive information via a Web system).

### EXAMPLE

Consider an office building that has five units (e.g., five different offices leased by five different tenants). In this case, an owner, a potential buyer, or a potential lender may be interested in predicting the income that will be generated by the property over the next five years.

The evaluation device 400 randomly predicts a market rent for the property for each of the five years. For example, the per square foot values of {$25.00, $25.50, $25.50, $26.00, $25.00} may be predicted for the property. Note that while the market rent for each year is randomly predicted, the prediction may be based in part on, for example, market rent survey and/or forecast information associated with a probability distribution.

The evaluation device 400 also randomly predicts vacancy time information for each tenant vacancy event. The vacancy time information may be based in part on, for example, forecasts for market vacancy rate, change in demand, or change in supply. For example, {zero weeks, zero weeks, two weeks, zero weeks, eight weeks} may be predicted for one office while {two weeks, zero weeks, zero weeks, zero weeks, zero weeks} is predicted for another office.

Based on the predicted market rents and vacancy information, the evaluation device 400 generates an income prediction for each of the five years. For example, incomes of {$25,000, $24,000, $30,000, $29,000, $29,000} may be predicted. After predicting the income for each of the five years, the evaluation device 400 repeats the process a number of times (e.g., one thousand times) in accordance with a Monte Carlo simulation to determine an income distribution. That is, if meaningful assumptions can be made with respect to the stochastic values that were used by the evaluation device 400 (e.g., that the market rent and vacancy probabilities are reasonably accurate), the Monte Carlo simulation can provide insight into the risk characteristics that are associated with the property and/or the potential loan (e.g., predicted default rates) by simulating a significant number of potential outcomes. A decision about a potential loan (e.g., an approval, a decline, or an adjustment to a potential loan parameter) can then be made in accordance with this insight.

Evaluation Method

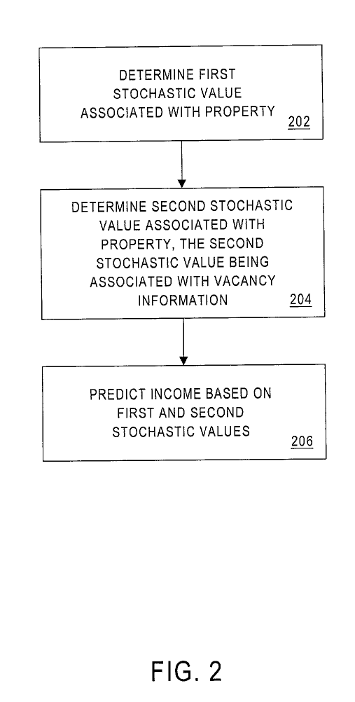

FIG. 2 is a flow chart of a method that may be performed by the evaluation device 400 according to some embodiments of the present invention. The flow charts in FIG. 2 and the other figures described herein do not imply a fixed order to the steps, and embodiments of the present invention can be practiced in any order that is practicable.

At 202, a first stochastic value associated with a property is determined. For example, the evaluation device 400 may retrieve the first stochastic value from a pre-generated series of values that were created via a stochastic process.

The first stochastic value may be associated with, for example, a predicted interested rate. In this case, the evaluation device 400 may retrieve a predicted interest rate from a pre-generated series of interest rates that were created via a stochastic process. According to another embodiment, the evaluation device 400 instead randomly generates a predicted interest rate. According to another embodiment, a formula associated with a probability distribution (e.g., a normal distribution, a triangular distribution, a uniform distribution, or a lognormal distribution) is used to randomly generate the first stochastic value. The formula associated with a probability distribution might be an n interest rate yield curve simulation.

The first stochastic value may instead be associated with a predicted market rent. In this case, the evaluation device 400 may retrieve a predicted market rent from a pre-generated series of market rents that were created via a stochastic process. According to another embodiment, the evaluation device 400 instead randomly generates a predicted mark rent (e.g., a per square foot rent) based on a market rent forecast and/or a market rent volatility model.

The first stochastic value may also be associated with other types of information, such as property expense information, capitalization rate information, and/or lease term information. Note that the first stochastic value may actually comprise a number of stochastic values (e.g., both an interest rate prediction and a market rent prediction).

At 204, a second stochastic value associated with the property is determined, the second stochastic value being associated with vacancy information. For example, vacancy time information and a vacancy time distribution may be randomly determined. The vacancy information may be generated, for example, in accordance with market demand information, market vacancy information, market supply information, and/or tenant renewal predictions. For example, a model may predict market vacancy and vacancy times may then be simulated for individual vacancy events. The vacancy events may be determined by a random determination of tenant renewal at the time of lease end.

At 206, income information associated with the property is determined based on the first and second stochastic values. For example, net operating income information may be predicted for the property. In addition, the value of the property investment may be predicted based on N years of discounted operating income returns, and the value of a sale in year N using a stochastic cap rate.

Based on the income information, debt service coverage ratio information may also be predicted. For example, the net operating income may be reduced by any applicable operating expenses and management fees to calculate a total income. The total income may then be divided by a debt service value to calculate a debt service coverage ratio (e.g., indicating that the property is profitable when the debt service coverage ratio is greater than “1.00”). Note that the debt service value may be based in part on a predicted interest rate that was determined at 202. According to one embodiment, the debt service coverage ratio is calculated and stored on a year-by-year basis (e.g., for each of ten years that are being evaluated). According to other embodiments, the debt service coverage ratio may instead be associated with a month or any other period (e.g., a quarter, a year, or a multi-year period).

The above process (i.e., a simulation “run”) may then be repeated a number of times with newly generated stochastic values in accordance with a Monte Carlo simulation. For example, a histogram may be generated to illustrate how often the debt service coverage ratio fell below a pre-determined value (e.g., “1.15”) during ten thousand simulation runs.

According to one embodiment, a potential loan is evaluated based on this debt service coverage ratio information. For example, a potential loan may be considered undesirable if the debt service coverage ratio falls below a predetermined value too frequently (e.g., resulting in a technical loan default in more than five percent of the simulation runs). In this case, one or more potential loan parameters may be adjusted based on the evaluation (e.g., to reduce the frequency at which the debt service coverage ratio falls below the pre-determined value).

In addition to predicting debt service coverage ratio information, the present invention may be used to predict loan to value information over a period of time. For example, a loan to value may be calculated and used to evaluate a potential loan (e.g., by comparing the predicted loan to value with a pre-determined value) and/or to adjust a potential loan parameter based on the evaluation.

The method illustrated in FIG. 2 may be performed for a single property (e.g., having a single unit or a plurality of units) or for a plurality of properties.

When the method is performed for a plurality of properties, a cross-correlation matrix may be utilized for the stochastic variables. For example, the cross-correlation matrix may be associated with the interaction of the stochastic parameters based on collateral type and/or geographic location.

Evaluation System Functions

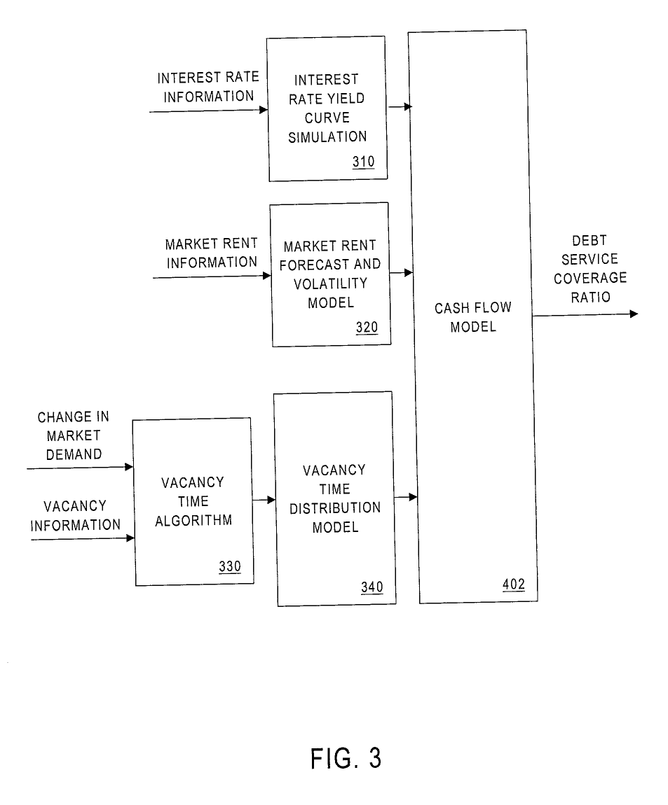

FIG. 3 is a functional diagram overview of an evaluation system including a cash flow model 402 that receives stochastic information from an interest rate yield curve simulation 310, a market rent forecast and volatility model 320, and a vacancy time distribution model 340.

The cash flow model 402 may also receive other information, such as information about a potential loan to be evaluated. The information about the potential loan may include, for example, a debt term, a flow-through lockbox arrangement, an earnout, an interest reserve, debt information (e.g., a borrower's overall debt), an interest rate cap assumption, a letter of credit, and/or a cash flow setup trigger. Similarly, the cash flow model 402 may receive information about tenants and/or leases associated with the property, such as information about a lease structure, an in-place rent, a scheduled rent increase, a letter of credit, and/or a lease period. The cash flow model 402 may also receive other information about the property, such as operating expense information and/or management fee information.

The interest rate yield curve simulation 310 may provide stochastic interest rate values to the cash flow model 402 based on received interest rate information (e.g., interest rate probabilities received from a third party). For example, an “off the shelf” interest rate yield curve simulation may be used to generate stochastic interest rate values.

The market rent forecast and volatility model 320 may provide stochastic market rent values (e.g., per square foot market rents) to the cash flow model 402 based on received market ret information (e.g., market rent probabilities received from a third party). According to one embodiment, the market rent values are based on the location and category of property being evaluated. For example, market rent values may be based on a ZIP code associated with a property. Similarly, office, warehouse, retail, and multifamily properties may be associated with different market rent values.

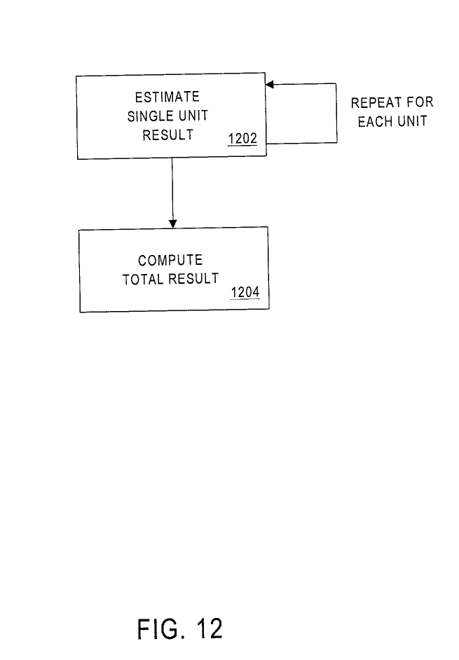

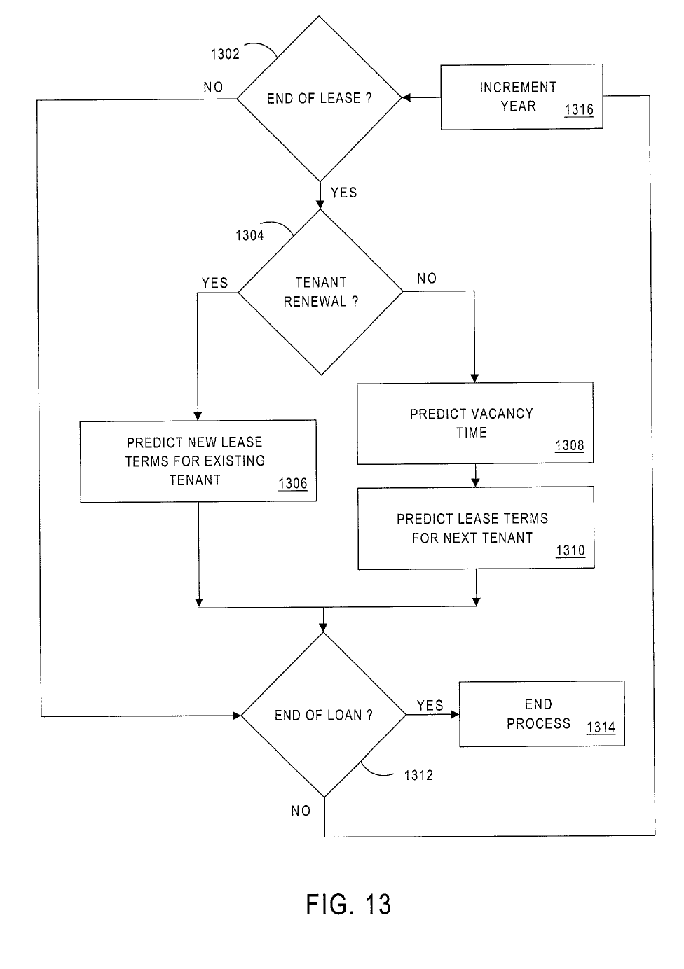

The vacancy time distribution model 340 may provide stochastic vacancy information (e.g., a predicted vacancy period) to the cash flow model 402 based on information generated by a vacancy time algorithm 330 (e.g., in accordance with a potential change in market demand and/or vacancy information received from a third party). FIGS. 12 and 13 illustrate methods for determining stochastic vacancy information according to one embodiment of the present invention.

Based on the stochastic information received from the interest rate yield curve simulation 310, the market rent forecast and volatility model 320, and the vacancy time distribution model 340, the cash flow model 402 generates a debt service coverage ratio. For example, a predicted net operating income may be reduced by any applicable operating expenses and management fees to calculate a predicted total income. The predicted total income may then be divided by a predicted debt service value to calculate a predicted debt service coverage ratio. This process may then be repeated a number of times with newly generated stochastic values in accordance with a Monte Carlo simulation.

According to another embodiment, the information described with respect to FIG. 3 is used to calculate loan to value information over a period of time instead of (or in addition to) the debt service coverage ratio.

Thus, embodiments of the present invention may replace subjective values, range estimates, and “what-if” scenarios with a comprehensive system that can analyze thousands of potential outcomes. Such an approach provides powerful pricing information to help make capital investment decisions.

Evaluation Device

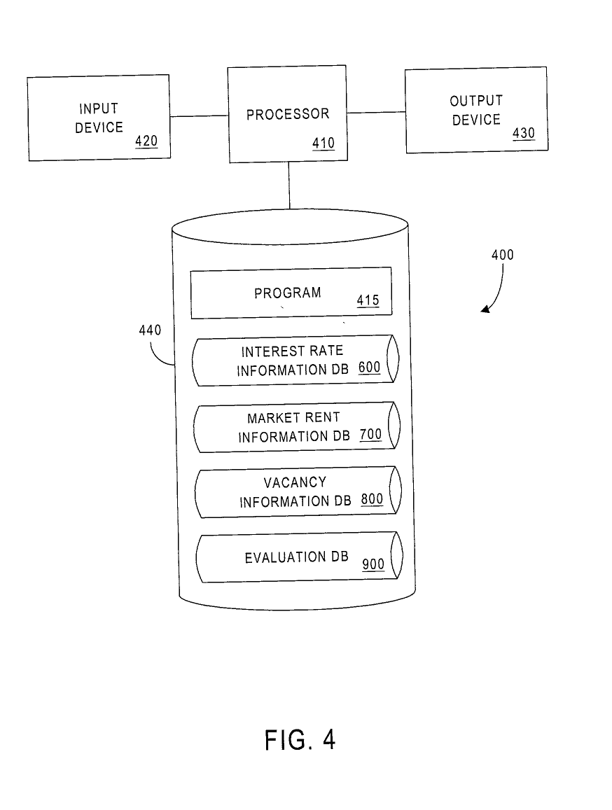

FIG. 4 illustrates an evaluation device 400 that is descriptive of the device shown, for example, in FIG. 1 according to some embodiments of the present invention. The evaluation device 400 includes a processor 410, such as one or more INTEL® Pentium® processors.

The processor 410 is in communication with an input device 420. The input device 420 may be, for example, a keyboard, a mouse or other pointing device, or a communication device (e.g., a modem or network device). Such an input device 420 may be used, for example, to enter information about a potential loan, a tenant, and/or a property. The input device 420 may also be used to enter information that will be used to generate stochastic values (e.g., market rent and vacancy values and probabilities).

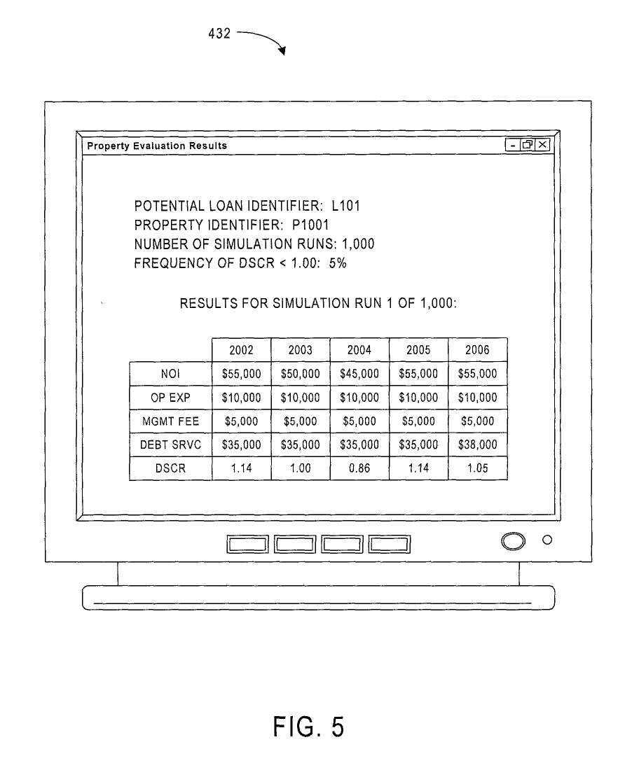

The processor 410 is also in communication with an output device 430. The output device 430 may be, for example, a display (e.g., a computer monitor) or a printer. The output device 430 may be used, for example, to display evaluation results to a user. FIG. 5 illustrates an output display 432 according to one embodiment of the present invention. In particular, multiyear results (including each year's debt service coverage ratio) for a number of simulation runs are being displayed to user. As can be seen in FIG. 5, the debt service coverage ratio was predicted to fall below “1.00” in year “2004.”

Referring again to FIG. 4, the processor 410 is also in communication with a storage device 440. The storage device 440 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 440 stores a program 415 for controlling the processor 410. The processor 410 performs instructions of the program 415, and thereby operates in accordance with the present invention. For example, the processor 410 may determine a first stochastic value associated with a property (e.g., a stochastic interest rate or market rent value). The processor 410 may also determine a second stochastic value associated with vacancy information. The processor 410 may then use the first and second stochastic values to predict income associated with the property.

According to one embodiment, the processor 410 determines stochastic interest rate and market rent values associated with a property along with a stochastic vacancy value and a random renewal probability. The processor 410 then predicts debt service coverage ratio information based on the stochastic values in accordance with a Monte Carlo simulation, and a potential loan is evaluated based on the debt service coverage ratio information.

As used herein, information may be “received” by or “transmitted” to a software application or module within the evaluation device 400 from another software application, module, or any other source.

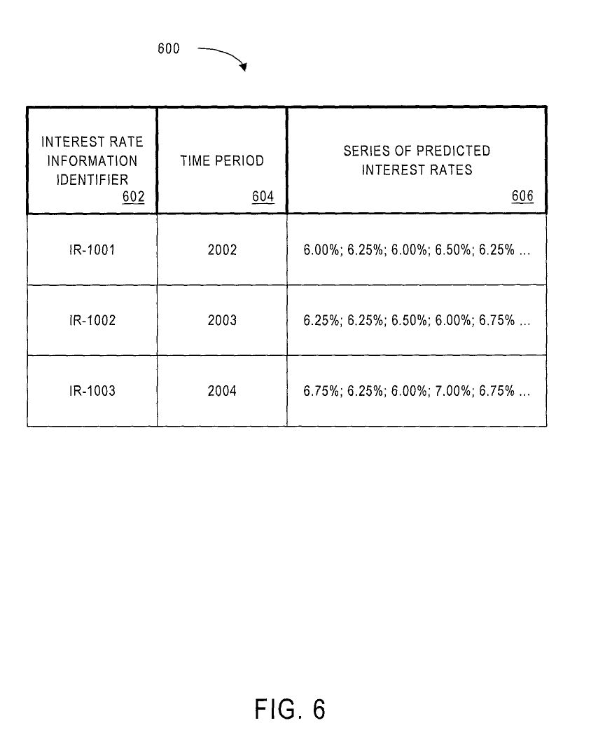

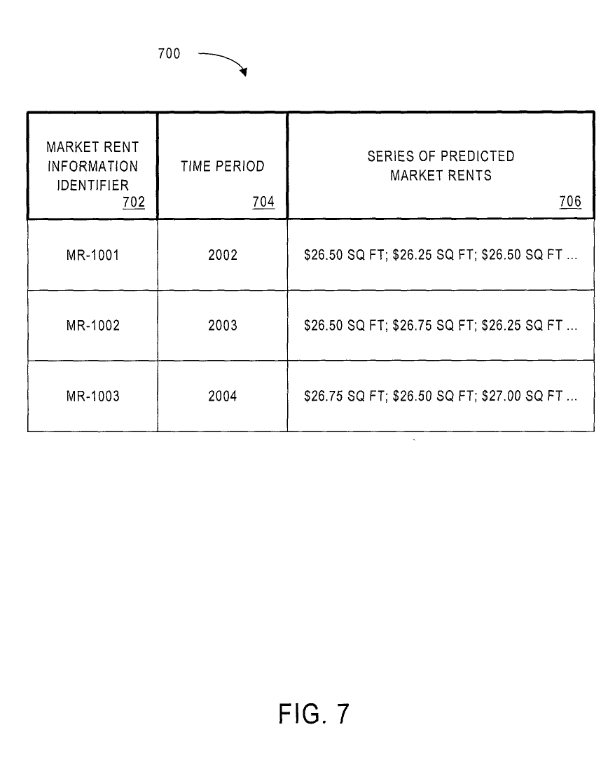

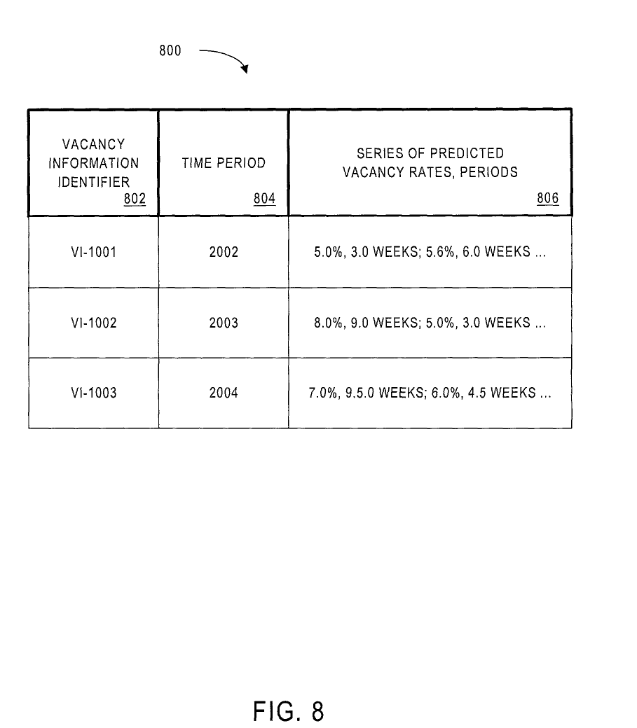

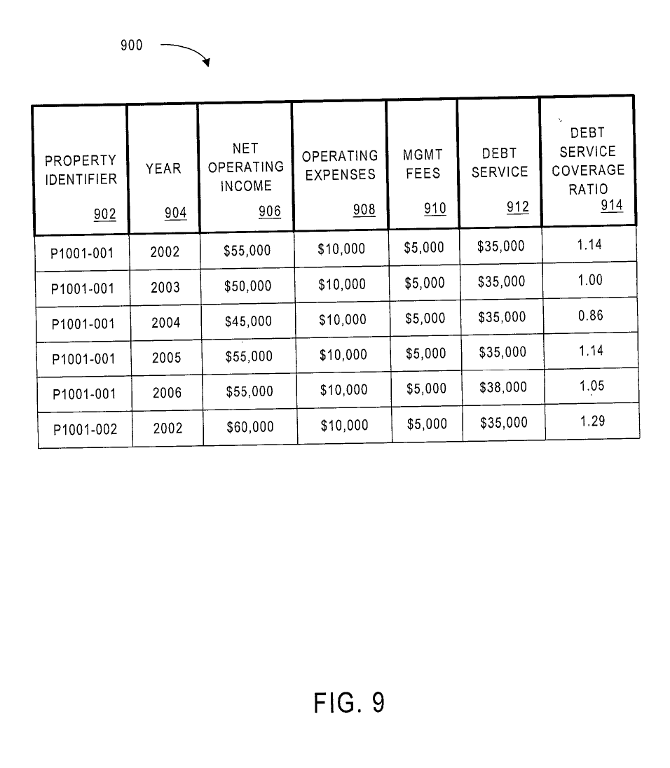

As shown in FIG. 4, the storage device 440 also stores an interest rate information database 600 (described with respect to FIG. 6), a market rent information database 700 (described with respect to FIG. 7), a vacancy information database 800 (described with respect to FIG. 8), and an evaluation database 900 (described with respect to FIG. 9). Examples of databases that may be used in connection with the evaluation device 400 will now be described in detail. The illustrations and accompanying descriptions of the databases presented herein are exemplary, and any number of other database arrangements could be employed besides those suggested by the figures.

Interest Rate Information Database

Referring to FIG. 6, a table represents the interest rate information database 600 that may be stored at the evaluation device 400 according to an embodiment of the present invention. The table includes entries identifying information that may be used to generate stochastic interest rate values during Monte Carlo simulation runs. The table also defines fields 602, 604, 606 for each of the entries. The fields specify: an interest rate information identifier 602, a time period 604, and a series of predicted interest rates 606. The information in the interest rate information database 600 may be created and updated, for example, based on information received from a third party (e.g., a financial prediction service or a governmental agency).

The interest rate information identifier 602 may be, for example, an alphanumeric code associated with a particular item of interest rate information. The series of predicted interest rates 606 represent a series of predicted interest rate values for the time period 604 that have been generated via a stochastic process. For example, the series of predicted interest rates 606 may contain five thousand predicted interest rate values that were calculated using a current interest rate yield curve and market volatility information. According to one embodiment, the series of predicted interest rates are generated via an algorithm that simulates interest rate dynamics, such as Cox-Ingersoll-Ross model or the Heath-Jarrow-Morton model.

According to another embodiment, the interest rate information database 600 instead stores information that lets the evaluation device 400 stochastically generate predicted interest rate values during simulation runs. For example, the interest rate information database 600 may store a beginning yield curve and a mean predicted interest rate value and a distribution function (e.g., associated with a standard deviation).

Other information may also be stored in the interest rate information database 600. For example, historic interest rates and/or interest rates associated with various loan amounts, borrowers, geographic locations, or property types may be stored in the interest rate information database 600. According to one embodiment, parameters for a distribution function are based at least in part on such historic information.

Moreover, interest rate and other information may instead be stored as follows: a set of interest rate, market rent, or vacancy series may be stored, where series 1 has a value for time period 1, 2, 3, . . . N and there are M total rate series.

Market Rent Information Database

Referring to FIG. 7, a table represents the market rent information database 700 that may be stored at the evaluation device 400 according to an embodiment of the present invention. The table includes entries identifying information that may be used to generate stochastic market rent values during Monte Carlo simulation runs. The table also defines fields 702, 704, 706 for each of the entries. The fields specify: a market rent information identifier 702, a time period 704, and a series of predicted market rents 706, and a market rent probability 708. The information in the market rent information database 700 may be created and updated, for example, based on information received from a third party (e.g., a real estate research group).

The market rent information identifier 702 may be, for example, an alphanumeric code associated with a particular item of market rent information. The series of predicted market rents 706 represent a series of predicted market rent values for the time period 704 that have been generated via a stochastic process. For example, the series of predicted market rents 706 may contain five thousand predicted market rent values that were calculated using a mean predicted market rent value and a distribution function (e.g., associated with a standard deviation).

According to another embodiment, the market rent information database 700 instead stores information that lets the evaluation device 400 stochastically generate predicted market rent values during simulation runs. For example, the market rent information database 700 may store a mean predicted market rent value and a distribution function or formula (e.g., associated with a standard deviation). Such information may be based on, for example, in-house expertise and/or a market rent forecast provided by a third party.

As another example, the market rent information database 700 instead stores a number of potential predicted mean market values, each value being associated with a probability based on, for example, economic scenarios. For example, in the year 2002 there may be a sixty percent chance that the market rent will be $26.50 per square foot, a twenty percent chance that the market rent will be $27.00 per square foot, and a twenty percent chance that the market rent will be $27.50 per square foot. A stochastic value can be predicted for each time period based on a distribution around the mean. Other information may also be stored in the market rent information database 700. For example, historic market rents and/or market rent associated with various lease terms, property sizes, borrowers, geographic locations, or property types may be stored in the market rent information database 700. According to one embodiment, parameters for a distribution function are based at least in part on such historic information.

Vacancy Information Database

Referring to FIG. 8, a table represents the vacancy information database 800 that may be stored at the evaluation device 400 according to an embodiment of the present invention. The table includes entries identifying information that may be used to generate stochastic vacancy values during Monte Carlo simulation runs. The table also defines fields 802, 804, 806 for each of the entries. The fields specify: a vacancy information identifier 802, a time period 804, and a series of predicted vacancy rates and periods 806. The information in the vacancy information database 800 may be created and updated, for example, based on information received from a third party (e.g., a real estate research group). These predicted vacancy rates can be for alternative economic scenarios and might be assigned a probability of occurrence according to the probability of the respective economic scenario.

The vacancy information identifier 802 may be, for example, an alphanumeric code associated with a particular item of vacancy information. The series of predicted vacancy rate and periods 806 represent a series of predicted vacancy rate and period values for the time period 804 that have been generated via a stochastic process. For example, the series of predicted vacancy rate and periods 806 may contain five thousand predicted vacancy rate and period values that were calculated using mean predicted vacancy rate and period values and a distribution function (e.g., associated with a standard deviation).

According to another embodiment, the vacancy information database 800 instead stores information that lets the evaluation device 400 stochastically generate predicted vacancy rate and period values during simulation runs. For example, the vacancy information database 800 may store mean predicted vacancy rate and period values and associated distribution functions or formulas (e.g., associated with standard deviations).

As another example, the vacancy rate and period information database 800 instead stores a number of potential predicted vacancy rate and period values, each associated with a probability. For example, in the year 2003 there may a ten percent chance that: (i) seven percent of all properties will become vacant in that year, and (ii) vacant properties will remain vacant, on average, for a period of six weeks.

In still another example, the vacancy information database 800 includes vacancy rates and periods for a base case scenario, a light recession scenario, and a severe recession scenario. Each of these scenarios may then be associated with a probability (e.g., the base case scenario may be associated with a fifty percent probability, the light recession scenario may be associated with a thirty five percent probability, and the severe recession scenario may be associated with a fifteen percent probability). The evaluation controller 400 can then select one of the scenarios (and thus the associated vacancy information) in accordance with those probabilities. In yet another embodiment, the evaluation controller 400 predicts one or more underlying economic conditions (e.g., an unemployment rate) and selects an appropriate scenario based on the that prediction.

Note that the predicted vacancy rate and the predicted vacancy period may be generated by separate stochastic processes. According to another embodiment, the predicted vacancy rate is generated by a stochastic process while the predicted vacancy period is calculated based on that predicted vacancy rate. Similarly, the predicted vacancy period could be generated by a stochastic process while the predicted vacancy rate is calculated based on that predicted vacancy period.

Other information may also be stored in the vacancy information database 800. For example, historic vacancy information and/or vacancy information associated with various lease terms, property sizes, borrowers, geographic locations, or property types may be stored in the vacancy information database 800. According to one embodiment, parameters for a distribution function are based at least in part on such historic information.

Evaluation Database

Referring to FIG. 9, a table represents the evaluation database 900 that may be stored at the evaluation device 400 according to an embodiment of the present invention. The table includes entries associated with a property being evaluated. The table also defines fields 902, 904, 906, 908, 910, 912, 914 for each of the entries. The fields specify: a property identifier 902, a year 904, a net operating income 906, operating expenses 908, management fees 910, a debt service 912, and a debt service coverage ratio 914. The information in the evaluation database 900 may be created and updated, for example, based on Monte Carlo simulation runs.

The property identifier 902 may be, for example, an alphanumeric code associated with a property being evaluated and/or a particular Monte Carlo simulation run. For example, the first five entries illustrated in FIG. 9 are associated with a first Monte Carlo simulation run (e.g., representing the five year period from year 2002 through year 2006) while the sixth entry is associated with a second simulation run (e.g., predicting year 2002 with a new set of stochastic values).

For each year 904, a net operating income 906 is predicted (e.g., based on stochastic information generated in accordance with information stored in the market rent information database 700 and the vacancy information database 800). The operating expenses 908 and the management fees 910 applicable in each year 904 are also calculated. Note that these values may be fixed (e.g., $5,000 each year), varied at a pre-determined rate (e.g., starting at $5,000 and increasing by five percent each year), calculated as a function of property performance, or stochastic.

The debt service 912 associated with a potential loan may be based on, for example, stochastic information generated in accordance with the information stored in the interest rate information database 600. The debt service coverage ratio 914 may then be calculated as follows: (net operating income 906−operating expenses 908−management fees 910)/(debt service 912).

Other information may also be stored in the evaluation database 900. For example, loan default information (e.g., a potential loss severity), tenant lease expirations, tenant rents, current market rent information, deal structure information, letter of credit information, interest rate cap information, cash flow triggers, earnout information, draw information, and inflation assumptions may be stored in the evaluation database 900.

Evaluation System Methods

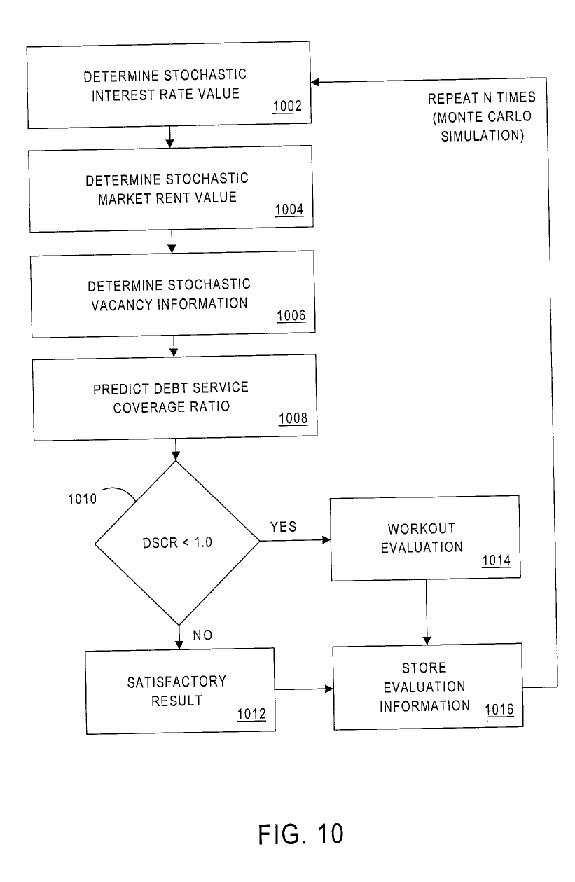

FIG. 10 is a flow chart of a Monte Carlo loan evaluation method according to some embodiments of the present invention. Before the method is performed, a user may input information about a potential loan to be evaluated. For example, the user may select a property (or type of property) from a list of properties (or property types). The user may also enter market information, such as a property area, a base rent per square foot, a base rent increase, a renewal probability, and an average vacancy time.

The user may also enter operating expense information, such as real estate tax and real estate tax growth rates, utilities expenses, insurance expenses, repair and maintenance expenses, general and administrative expenses, tenant improvement expenses, advertising expenses, payroll expenses, and/or operating expense growth rates. Similarly, the user may enter tenant information, such as a tenant name (or names, in the case of a multi-unit property), a market type, a lease area, a per square foot lease rent, lease start and end dates, and/or scheduled rent increases.

A stochastic interest rate value associated with the property is then determined at 1002. For example, the evaluation device 400 may retrieve one of the series of predicted interest rates 606 from the interest rate information database 600. At 1004, a stochastic market rent value associated with the property is determined. For example, the evaluation device 400 may retrieve one of the series of predicted market rents 706 from the market rent information database 700.

At 1006, stochastic vacancy information associated with the property is determined (e.g., the evaluation device 400 may retrieve one of the series of predicted vacancy rates and periods 806 from the vacancy information database 800).

At 1008, a debt service coverage ratio associated with the property for a given time period (e.g., a quarter) is predicted based on the stochastic values. For example, the evaluation device 400 may calculate the debt service coverage ratio based on the stochastic interest rate value, the stochastic market rent value, and the stochastic vacancy information. Note that other information may also be used to calculate the debt service coverage ratio, including occupancy information, rent growth, expense growth, a cap rate, a market rent, down time, renewal probability, required tenant improvements, leasing commissions, and/or lease terms.

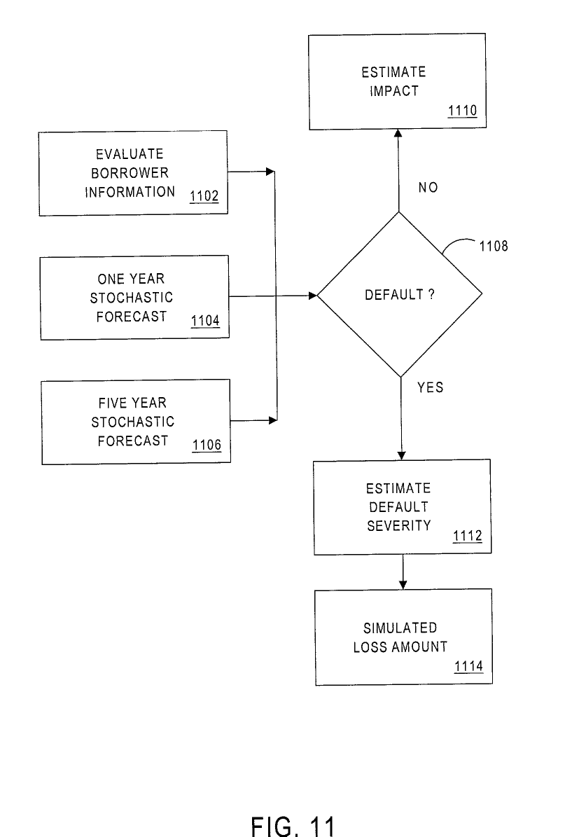

If the debt service coverage ratio is not less than a pre-determined value at 1010 (i.e., not less than “1.0”), the result is satisfactory at 1012. That is, the evaluation device 400 may predict that there would be no loan default based on the particular stochastic values that were generated. If the debt service coverage ratio is less than a pre-determined value at 1010, a workout evaluation is performed at 1014 (e.g., to determine an amount associated with a loan default). One example of a loan workout method is described with respect to FIG. 11.

In either case, the evaluation result is stored at 1016 (e.g., in the evaluation database 900) and the process is repeated for other properties, other years, and/or other Monte Carlo simulation runs. After multiple simulation runs are completed, a histogram and other statistics may be displayed to the user based on the evaluation results. For example, the CRYSTAL BALL™ software program may be used to generate charts (e.g., frequency charts, contribution of variables, and trend charts) to facilitate sophisticated scenario analysis. The simulation can also be run using other third party software, code, or a mix of methods. Moreover, the probability of book loss and/or the extent of book loss may be displayed to a user.

According to another embodiment, loan to value information is predicted based on stochastic values (e.g., instead of, or in addition to, predicting the debt service coverage ratio information predicted at 1008). Such a prediction may be based on, for example, a capitalization rate (which itself may be fixed or stochastic) that is applied to a predicted net operating income. According to this embodiment, the loan to value information may then be used to evaluate the potential loan at 1010 (e.g., by comparing the loan to value information to a pre-determined value, such as “100%”).

FIG. 11 is a flow chart of a loan workout method according to some embodiments of the present invention. The method may be performed, for example, by the evaluation device 400 to predict a loan workout result when a simulation run results in a debt service coverage ratio that is less than a predetermined value (e.g., causing the loan to be in technical default).

At 1102, borrower and collateral information is evaluated. For example, a borrower deferred tax liability, a borrower litigation history, a loan amount, a borrower worth, other borrower loans, loan to value information, borrower equity, and/or borrower capital may be evaluated to estimate the borrower's willingness to provide payment with respect to the potential loan. According to one embodiment, the loan to value of the potential loan at the time of default (or a subsequent time period) is used to predict borrower behavior (and/or a default severity). A one-year stochastic forecast is evaluated at 1104, and a five-year stochastic forecast is evaluated at 1106 (e.g., to evaluate the borrower's prospects with respect to being able to provide payment with respect to the potential loan).

If a loan default is not predicted at 1108 based on these evaluations (e.g., based on predicted debt service coverage ration and/or loan to value information), the impact of the loan workout is determined at 1110. If a loan default is predicted at 1108, the severity of the loan default is estimated at 1112 along with a simulated loss amount for the lender at 1114.

FIG. 12 is a flow chart of a multi-unit evaluation method according to some embodiments of the present invention. The method may be performed, for example, when a property having a plurality of units is evaluated (e.g., an office building having a number of different tenants). At 1202, a result for a single unit is estimated. One method for estimating a result for a single unit is described with respect to FIG. 13. This step is repeated for each unit associated with the property. After a result has been estimated for every unit, a total result associated with the property is computed at 1204. Note that the method shown in FIG. 12 may be performed a number of times in accordance with a Monte Carlo simulation.

FIG. 13 is a flow chart of a single unit evaluation method according to some embodiments of the present invention. As will be explained, the process shown in FIG. 13 may be performed for a number of different years (as well as a number of different simulation runs).

The process begins with the first year of the evaluation period (e.g., an evaluation period associated with a five year loan). If the lease associated with a unit does not expire during that year at 1302, it is determined if the end of the evaluation period has been reached at 1312. That is, if the process has reached the end of the evaluation period the process can end at 1314. If the process has not reached the end of the evaluation period, the year being evaluated is incremented at 1316.

When the end of a unit's lease is encountered at 1302, a prediction is made at 1304 as to whether or not the tenant associated with the unit will renew the lease. This may be performed, for example, using a random process (e.g., it might be assumed that there is a seventy percent chance that a tenant will renew a lease). Note that this random process may also be a function of market conditions and property characteristics. If it is predicted that the tenant will renew the lease, new lease terms are predicted for the existing tenant at 1306 (e.g., a new lease period and a per square foot rent). Note that, in this case, the unit is not vacant for any period of time.

If it is predicted that the tenant will not renew the lease at 1304, however, vacancy time information is predicted at 1308. That is, the evaluation device 400 predicts an amount of time during which no tenant occupies the unit (and thus no income will be generated by that unit). This may be performed, for example, using an average vacancy period, a distribution of vacancy periods (e.g., a Poisson distribution), or information stored in the vacancy information database 800. In addition, lease terms are predicted for the next tenant at 1306 (e.g., a new lease period and a per square foot rent). According to one embodiment, a tenant improvement value and leasing commission are also estimated.

The process is then repeated for each year until the end of the evaluation period is reached at 1312. The income that will be generated by the unit (e.g., including any vacancy periods and adjusted lease terms) can then be calculated. According to one embodiment, tenant improvements and leasing commissions are also calculated according to stochastic inputs.

The predictions described with respect to FIG. 13 may be performed in any number of ways. For example, vacancy time may be a function of a market vacancy rate, a property type and quality, a change in supply, a change in demand, a total market size, and/or a market absorption rate.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments of the present invention have been described with respect to a potential loan evaluation, the invention may also be used to evaluate existing loans (e.g., to determine whether or not an existing loan should be assumed or re-financed). Moreover, the present invention may be used to predict income information associated with a property for any other purpose (e.g., to appraise real estate) and for a portfolio of loans and/or equity.

Similarly, although a single evaluation device 400 is described with respect to FIG. 1, any number of devices may be involved in the evaluation. For example, the databases described herein may be remotely stored and/or distributed. Moreover, the input device 420 and the output device 430 described with respect to FIG. 4 do not need to be co-located with the evaluation device 400 (e.g., the output device 430 may be a remotely located PC that accesses information via an intranet Web site).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of evaluating a property, comprising:
determining a first stochastic value associated with the property;
determining a second stochastic value associated with the property, the second stochastic value being associated with vacancy information; and
predicting income associated with the property based on the first and second stochastic values.

2. The method of claim 1, wherein said determinations of the first and second stochastic values are repeated, and said predicting is performed in accordance with a Monte Carlo simulation to determine an income distribution.

3. The method of claim 1, wherein the first stochastic value is associated with an interest rate yield curve simulation.

4. The method of claim 1, wherein the first stochastic value is associated with a market rent forecast.

5. The method of claim 4, wherein the first stochastic value is further associated with a market rent volatility model.

6. The method of claim 1, wherein the first stochastic value is associated with at least one of: (i) property expense information, (ii) capitalization rate information, and (iii) lease term information.

7. The method of claim 1, wherein the second stochastic value comprises vacancy time information.

8. The method of claim 7, wherein the vacancy time information comprises a vacancy time distribution.

9. The method of claim 7, wherein the vacancy time information is based on at least one of: (i) market demand information, (ii) market vacancy information, and (iii) market supply information.

10. The method of claim 7, wherein vacancy time information is associated with a tenant renewal prediction.

11. The method of claim 1, wherein an evaluation is further based on at least one of: (i) potential loan information, (ii) a lease structure, (iii) a rent, (iv) a scheduled rent increase, (v) a rent term, (vi) a debt term, (vii) a cash flow trigger, (viii) a flow-through lockbox, (ix) an earnout, (x) an interest reserve, (xi) debt information, (xii) an interest rate cap assumption, (xiii) operating expense information, and (xiv) management fee information.

12. The method of claim 1, wherein said predicting is performed for a plurality of properties.

13. The method of claim 12, wherein a cross-correlation matrix is utilized for the stochastic variables.

14. The method of claim 12, wherein said predicting is performed for each of the plurality of properties based on the first and second stochastic values.

15. The method of claim 1, wherein said predicting is performed for a property having a plurality of units.

16. The method of claim 1, wherein said predicting is performed for a plurality of time periods.

17. The method of claim 1, wherein said predicting comprises predicting net operating income information.

18. The method of claim 1, further comprising:
predicting the value of the property investment based on N years of discounted operating income returns, and the value of a sale in year N using a stochastic cap rate.

19. The method of claim 1, wherein said predicting comprises calculating debt service coverage ratio information.

20. The method of claim 19, wherein the debt service coverage ratio information is calculated based on net operating income information, operating expense information, management fee information, and debt service information.

21. The method of claim 19, further comprising:
evaluating a potential loan based on the debt service coverage ratio information.

22. The method of claim 21, wherein said evaluating comprises comparing the debt service coverage ratio information with a pre-determined value.

23. The method of claim 21, further comprising:
adjusting a potential loan parameter based on said evaluation.

24. The method of claim 19, further comprising:
predicting a loan workout result.

25. The method of claim 24, wherein said predicting is based on at least one of: (i) a borrower deferred tax liability, (ii) a borrower litigation history, (iii) a loan amount, (iv) a borrower worth, (v) other borrower loans, (vi) loan to value information, (vii) borrower equity, and (viii) borrower capital.

26. The method of claim 24, wherein said predicting is based on a stochastic forecast.

27. The method of claim 24, wherein the loan workout result is associated with a predicted loss amount.

28. The method of claim 1, wherein said predicting comprises calculating loan to value information.

29. The method of claim 28, further comprising:
evaluating a potential loan based on the loan to value information.

30. The method of claim 29, wherein said evaluating comprises comparing the loan to value information with a pre-determined value.

31. The method of claim 29, further comprising:
adjusting a potential loan parameter based on said evaluation.

32. A computer-implemented method of evaluating a property, comprising:
determining a series of stochastic interest rate values associated with the property over a period of time;
determining a series of stochastic market rent values associated with the property over the period of time;
determining a series of stochastic vacancy values associated with the property over the period of time;
predicting debt service coverage ratio information associated with the property based on the stochastic values, wherein said determinations of the stochastic values are repeated, and said predicting is performed in accordance with a Monte Carlo simulation; and
evaluating a potential loan based on the debt service coverage ratio information.

33. An apparatus, comprising:
a processor; and
a storage device in communication with said processor and storing instructions adapted to be executed by said processor to:
determine a first stochastic value associated with a property,
determine a second stochastic value associated with the property, the second stochastic value being associated with vacancy information, and
predict income associated with the property based on the first and second stochastic values.

34. The apparatus of claim 33, wherein said storage device further stores at least one of: (i) an interest rate information database, (ii) a market rent database, (iii) a vacancy information database, and (iv) an evaluation database.

35. A medium storing instructions adapted to be executed by a processor to perform a method of evaluating a property, said method comprising:
determining a first stochastic value associated with the property;
determining a second stochastic value associated with the property, the second stochastic value being associated with vacancy information; and
predicting income associated with the property based on the first and second stochastic values.

36. A method of evaluating a property, comprising:
determining a stochastic vacancy value associated with the property; and
predicting income associated with the property based on the stochastic vacancy value.
